(19) United States
(12) Patent Application Publication
(10) Pub. No.: US 2015/0305414 A1
(43) Pub. Date: Oct. 29, 2015

(54) Lighted Clothing

(71) Applicant: Randy Garbrick, Shoreline, WA (US)

(72) Inventor: Randy Garbrick, Shoreline, WA (US)

(21) Appl. No.: 14/694,832

(22) Filed: Apr. 23, 2015

Related U.S. Application Data
(60) Provisional application No. 61/983,449, filed on Apr. 23, 2014.

(51) Int. Cl. A41D 13/01; F21L 4/08; F21V 8/00; F21V 33/00

(52) U.S. Cl. CPC A41D 13/01; F21V 33/0008; F21L 4/08; G02B 6/0005; F21W 2111/10

(57) ABSTRACT

Lighted articles of clothing may have lighting in a removal liner. An outer shell may be translucent, transparent, or may have openings which allows the lighting to be visible from outside the article. The removable liner may be easily removable to enable washing of the article or reconfiguration of lighting characteristics including, but not limited to, change of color, pattern, type of lighting source, or quantity of lights.

### FIELD

This disclosure relates generally to lighted clothing.

### BACKGROUND

A person may wear articles of clothing for protection from the elements. For example, a jacket may protect its wearer from cold or wind. Reflective material may add an extra factor for safety, allowing a wearer to be more visible if headlights shine on the material.

### SUMMARY

The following presents a simplified summary of the disclosure to provide a basic understanding to the reader. This summary is not an extensive overview of the disclosure, nor does it identify key or critical elements of the claimed subject matter or define its scope. Its' sole purpose is to present some concepts disclosed in a simplified form as a precursor to the more detailed description that is later presented.

The present disclosure relates to an article of clothing in which lighting disposed inside the article may be visible outside the article by passing through the article. The lighting may be easily removable to enable washing of the article or reconfiguration of lighting characteristics including, but not limited to, change of color, pattern, type of lighting source, or quantity of lights. Another embodiment of the present invention may allow adding the features of the first embodiment to an existing article of clothing.

### BRIEF DESCRIPTION OF THE DRAWINGS

Following is a brief description of the drawings that will be used to describe the advantages and features of the present invention.

FIG. 1 shows a removable lining partially removed from a lighted jacket to display both a front side and a reverse side, according to one embodiment.

FIG. 2 shows a front side of a lighted jacket liner, according to one embodiment.

FIG. 3 displays a reverse view of a lighted jacket liner, according to one embodiment.

FIG. 4 displays a reverse view of a lighted jacket, according to one embodiment.

### DETAILED DESCRIPTION

Reference is now made in detail to the description of the embodiments as illustrated in the drawings. In the following detailed description, reference is made to the accompanying drawings which form a part hereof wherein like numerals designate like parts throughout, and in which are shown, by way of illustration, specific embodiments in which the disclosure may be practiced. Various aspects of the illustrative embodiments will be described using terms commonly employed by those skilled in the art to convey the substance of their work to others skilled in the art. However, the embodiments described herein may be practiced with only some of the described aspects. For purposes of explanation, specific numbers, materials, and configurations may be set forth to provide a thorough understanding of the illustrative embodiments. However, the embodiments described herein may be practiced without the specific details. In other instances, well-known features are omitted or simplified in order not to obscure the illustrative embodiments. Further, various operations may be described as multiple discrete operations, in turn, in a manner that may be helpful in understanding the embodiments described herein; however, the order of description should not be construed as to imply that these operations are necessarily order-dependent. In particular, these operations need not be performed in the order of presentation.

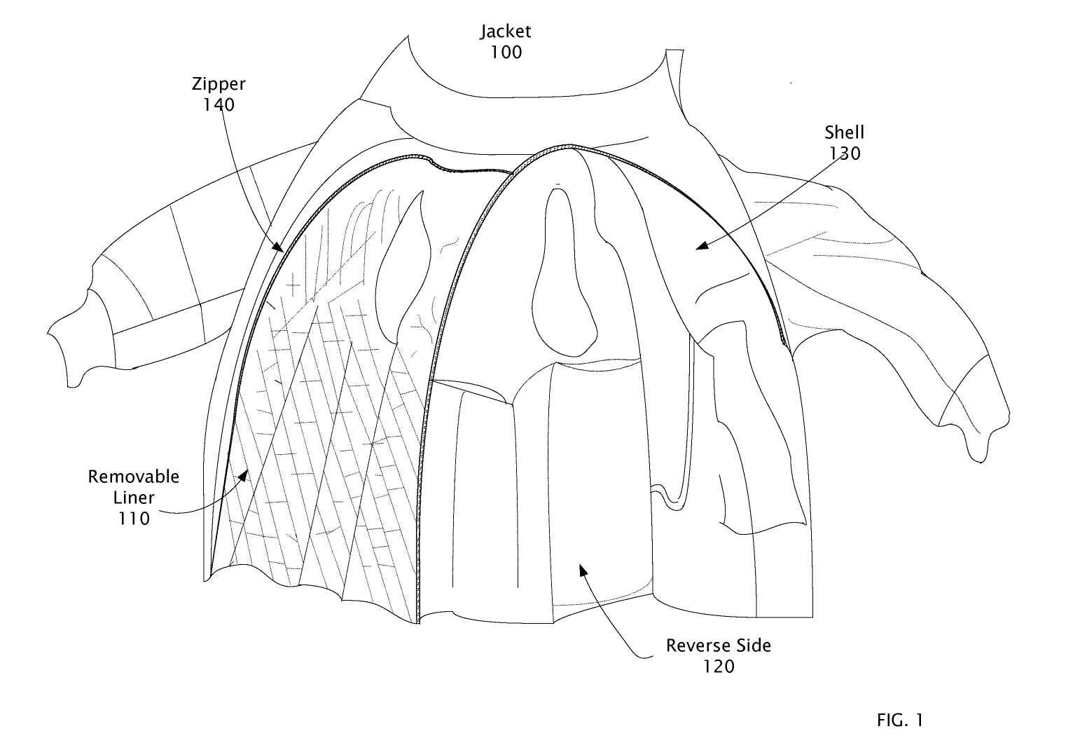

FIG. 1 shows Removable Liner 110 partially removed from Jacket 100 to display both a front side and a reverse side, according to one embodiment.

Removable Liner 110 is shown here partially removed in order to illustrate Reverse Side 120, which may have a plurality of channels, loops, hooks, webbings, or pockets, which may be configured to hold lighting or other electronic devices. Jacket 100 may be made of transparent or translucent material, or may have transparent or translucent sections, or may have holes, which may allow lighting disposed into Removable Liner 110 to be seen while Jacket 100 is worn by a user. Light sources, such as light-emitting diode strings, fiber optics, electroluminescent wire, fiber optics, or other light sources, may be installed, removed or reconfigured, which may allow for cleaning of the garment, replacement of non-functioning light sources, or changing the lighting characteristics such as color, intensity or pattern. Other types of electronics may also be disposed in Removable Liner 110, and may share a common power supply, charging system, or wiring bus, for example. One having ordinary skill in the art will recognize there may be many uses for Removable Liner 110 configured to hold electronic devices. Shell 130 may be of a color, thickness, and design to allow transmission of light through it from Removable Liner 110.

Removable Liner 110 may be removed from the Shell 130 to allow Shell 130 to be washed, which may allow the configuration of lighting or other electronics to remain in Removable Liner 110. Removable Liner 110 may be attached by Zipper 140. Other means of attachment may include, buttons, snaps or hook and loop fastener strips, for example, Velcro®.

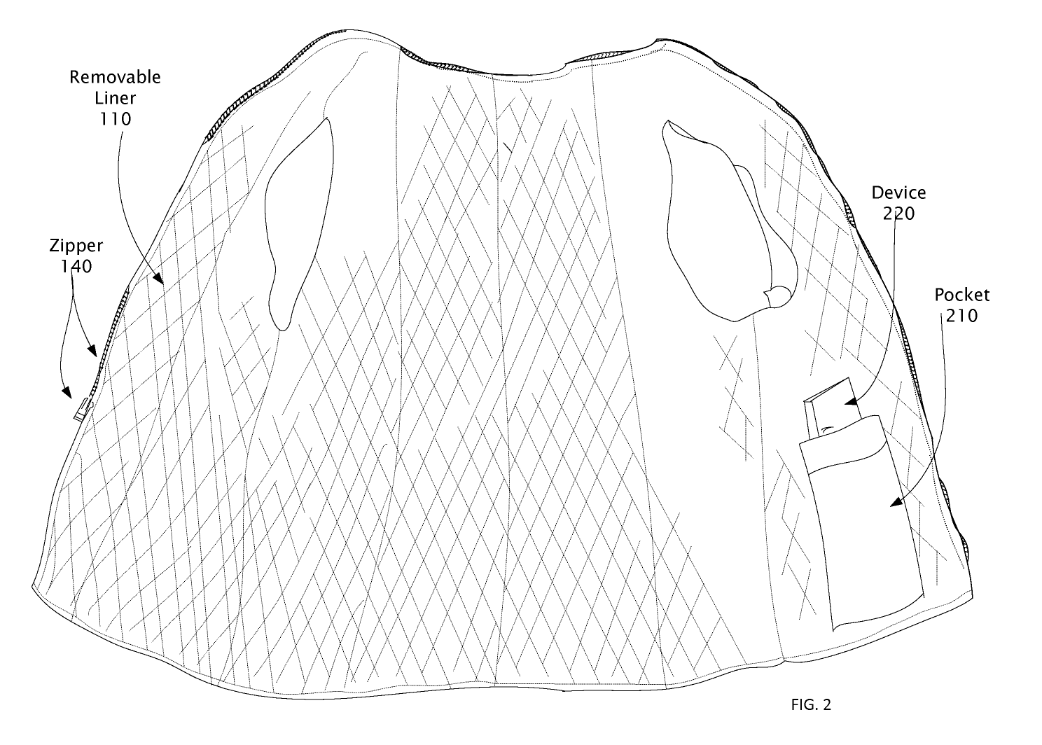

FIG. 2 shows a front side of Removable Liner 110, according to one embodiment. In one embodiment, Removable Liner 110 may be attached to another garment, for example, a jacket, by means of Zipper 140. Removable Liner 110 may have Pocket 220, positioned to allow easy access to Device 220, which may be, for example, a lighting power supply or a controller, which may allow the wearer to activate, deactivate, replace batteries, or otherwise control the characteristics of electronics. For example, Device 220 may include a dimer, a switch to control a lighting chase sequence, or a simple switch. One having skill in the art will recognize that Device 220 may control many different types of electronics in many different ways.

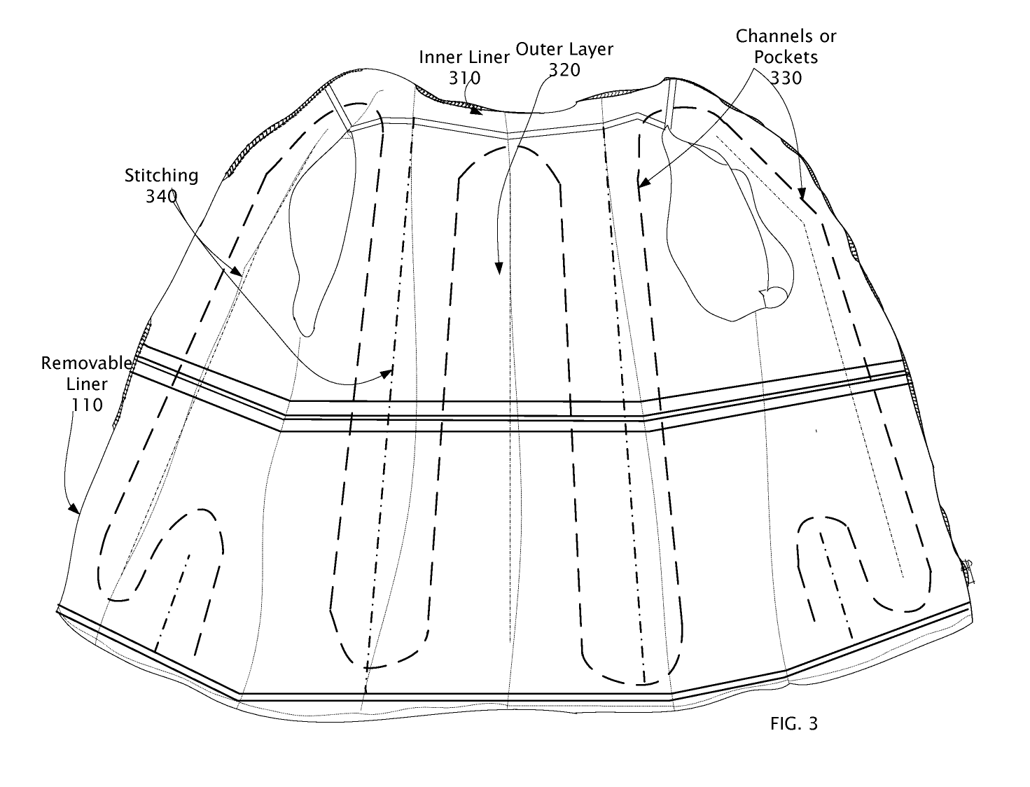

FIG. 3 shows a reverse side of Removable Liner 110. The reverse side of Removable Liner 110 may be composed of multiple layers. One embodiment may have Inner Layer 310, made of a reflective material in order to direct the light out through Jacket 100. Outer Layer 320 may be made from transparent or translucent material to allow transmission of light through Jacket 100. Outer Layer 320 may be attached to Inner Layer 310 to create Channels or Pockets 330, which may be open on the top, center or bottom. Outer Layer 320 may be Stitched 340, glued, or otherwise attached, to Inner Layer 310, which may impart a zigzag pattern to Channels or Pockets 330. A light source, for example, light emitting diode strings, fiber optics, or electroluminescent wire, may be inserted into Channels or Pockets 330. One or more holes may be provided in Inner Layer 310 to allow, for example, electrical power leads to pass through from the Inner Liner 310, which may allow a power supply or light controller disposed in Channels or Pockets 330 to connect to a linear light source.

In another embodiment, Lighted Clothing may provide a liner with a means to attach to an existing garment. Attachment methods may include, for example, buttons, snaps, or hook and loop fasteners. This may provide a removable lighted liner into which linear light sources such as light-emitting diode strings, fiber optics, or electroluminescent wire may be installed, removed or reconfigured to allow for cleaning of the garment, replacement of non-functioning light sources or changing the lighting characteristics such as color, intensity or pattern. This may allow an existing garment to be used while allowing lights to enhance safety or aesthetics.

In yet another embodiment, similar enhancements may be applied to other garments or apparel, for example pants, hats, sweatshirts, shoes, socks, lingerie, ski masks, vests, scarfs, gloves and underwear.

In yet another embodiment, Lighted Clothing may include energy harvesting and/or storage devices, for example, an integrated solar generating device. An energy storage device may be attached directly to lighting device or may allow for other components or accessories to be connected providing continuous power, or an ability to connect power to charge a battery, for example. In yet another embodiment, controls may be accessible in an integrated manner on the exterior of Lighted Clothing.

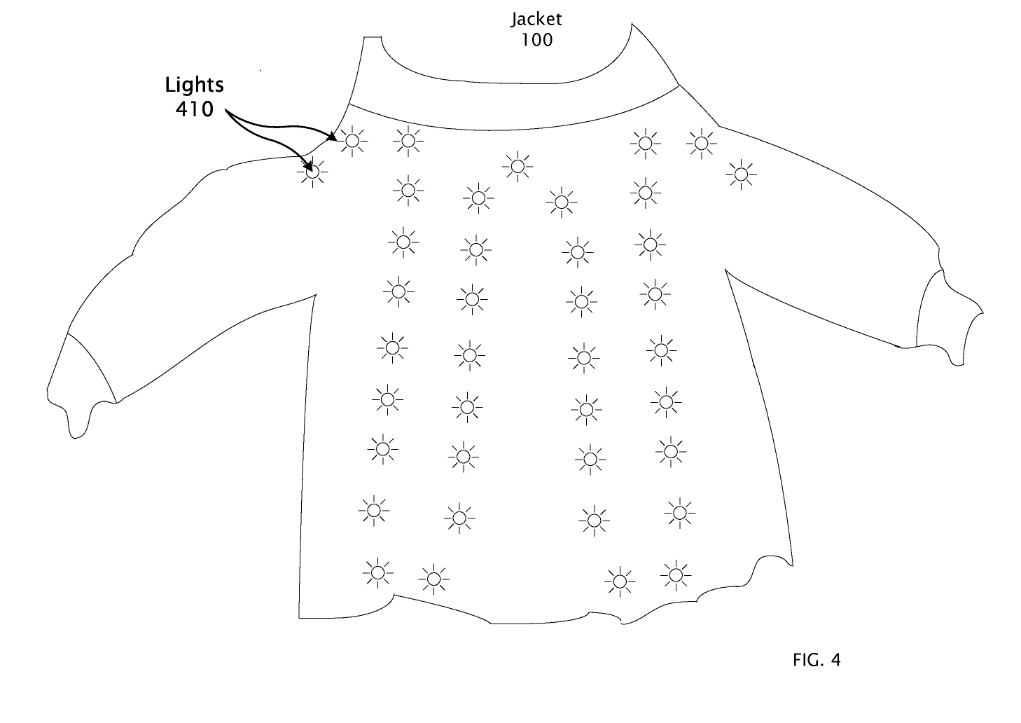

FIG. 4 displays a reverse view of a jacket 100, according to one embodiment. Lights 410 may be disposed in Removable Liner 110 inside Jacket 100. Lights 410 may, for example, be light-emitting diode strings, fiber optics, or electroluminescent wire. Lights 410 may show as points or short lengths of light, or may be continuous along Channels or Pockets 330 in Removable Liner 110.

The foregoing description of various embodiments of the invention has been presented for the purposes of illustration and description. It is not intended to be exhaustive or to limit the invention to the precise form disclosed. It is intended that the scope of the invention be limited not by this detailed description, but rather by the claims appended hereto. The above specification, examples and data provide a complete description of the manufacture and use of the invention. Since many embodiments of the invention can be made without departing from the spirit and scope of the invention, the invention resides in the claims hereinafter appended.

1. Lighted clothing, comprising:
a removable lining, comprising a means of holding a light source;
a shell; and
an attachment means removably coupling the lining and the shell.

2. The lighted clothing of claim 1 wherein the means of holding the light source comprises channels.

2. The lighted clothing of claim 1 wherein the means of holding the light source comprises pockets.

4. The lighted clothing of claim 1 wherein the means of holding the light source comprises webbing.

5. The lighted clothing of claim 1 wherein the shell is transparent.

6. The lighted clothing of claim 1 wherein the shell is translucent.

7. The lighted clothing of claim 1 wherein the shell forms walls providing openings, the openings allowing at least one portion of the light source to be visible from an outside of the lighted clothing.

8. The lighted clothing of claim 1 further comprising a light source.

9. The lighted clothing of claim 8 wherein the light source is removable from the lining.

10. The lighted clothing of claim 8 wherein the light source is selected from the set containing a light emitting diode string, fiber optics, and electroluminescent wire.

11. The lighted clothing of claim 1 further comprising a charging component.

12. The lighted clothing of claim 11 wherein the charging component is a battery.

13. The lighted clothing of claim 12 wherein the charging component is a solar charger.
